(19) United States
(12) Patent Application Publication
(10) Pub. No.: US 2014/0268649 A1
(43) Pub. Date: Sep. 18, 2014

(54) RETROFIT LED MODULE

(71) Applicant: MAN-D-TEC, INC., Scottsdale, AZ (US)

(72) Inventors: Dalton J. Mandy, Scottsdale, AZ (US); Terry R. Mandy, Paradise Valley, AZ (US); Brandon R. Mandy, Scottsdale, AZ (US)

(21) Appl. No.: 13/856,588

(22) Filed: Apr. 4, 2013

Related U.S. Application Data
(60) Provisional application No. 61/788,081, filed on Mar. 15, 2013.

(51) Int. Cl. F21K 99/00

(52) U.S. Cl. CPC F21K 9/13; F21K 9/90
USPC 362/95; 29/825

(57) ABSTRACT

An LED retrofit assembly including an LED module comprising an LED lamp, and a power supply module coupled to the LED lamp. The power supply conditions power received from an external power source to power the LED lamp and is mountable remotely from the LED module. The LED module is removably supportable by a bayonet base lamp socket.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND

1. Field

This application relates generally to the retrofit of LED lamps into light fixtures that are configured to carry and power bayonet base lamps.

2. Description of Related Art Including Information Disclosed Under 37 CFR 1.97 AND 1.98

Replacement LED lamps, or LED modules comprising one or more LED lamps have been designed for insertion into existing bayonet base lamp fixtures in place of bayonet base lamps, e.g., halogen lamps, for which the fixtures were designed. But the housings of bayonet base lamp fixtures tend to limit the area available for heat dissipation, potentially limiting LED life. Also, power supplies of the existing bayonet base lamp fixtures may include magnetic transformers that are not entirely compatible with LED lamps. Such power supplies may be further incompatible with LED lamps where they include electronic dimmers configured to attenuate lamp output.

### SUMMARY

An LED retrofit assembly for a bayonet base lamp socket may comprise an LED module comprising an LED lamp, and a power supply module coupled to the LED lamp. The power supply may be configured to condition power received from an external power source to power the LED lamp, and further configured to be mounted remotely from the LED module. The LED module may be configured to be removably supported by a bayonet base lamp socket in a position to emit light in a desired direction when the power supply is energizing the LED module.

A method for installing an LED retrofit assembly may include the following steps: A power supply of an LED retrofit assembly may be disposed in a location remote from a bayonet base lamp socket in which an LED module of the assembly is to be supported. The power supply may be connected to an LED lamp of the LED module. A portion of the LED module may be axially inserted into the bayonet base lamp socket. The LED module may be engaged in the bayonet base lamp socket against axial separation by rotating the LED module relative to the bayonet base lamp socket.

### DRAWING DESCRIPTIONS

These and other features and advantages will become apparent to those skilled in the art in connection with the following detailed description and drawings of one or more embodiments of the invention, in which:

FIG. 1 is a fragmentary cutaway perspective view of an elevator passenger compartment showing an LED retrofit assembly module installed in an existing bayonet base lamp fixture housing in a ceiling panel of the passenger compartment;

FIG. 2 is cross-sectional side view of the LED module of FIG. 1 installed in the existing bayonet base lamp fixture housing of FIG. 1 showing an LED retrofit assembly power supply module coupled between the LED module and an external electrical source, and showing an installation/removal tool engaged in tang receptacles of the LED module; and

FIG. 3 is an exploded perspective view of the LED retrofit assembly, bayonet base lamp fixture, and installation/removal tool of FIG. 2, with a bayonet base lamp fixture socket shown exploded from its location within the bayonet base lamp fixture lamp housing.

### DETAILED DESCRIPTION

An LED module retrofit assembly for a bayonet base lamp fixture such as a down light fixture for directing light downward from the ceiling area of a room, such as an elevator passenger compartment, is generally shown at 10 in FIGS. 1-3. The assembly 10 may include an LED module 12, which may comprise an LED lamp 14. In the present embodiment the LED module 12 comprises a single LED lamp but in other embodiments may include any number of LED lamps 14. The LED module 12 may be configured to be received in an existing bayonet base lamp fixture housing 18 and removably engaged with and supported by a bayonet base lamp socket carried by the existing lamp fixture housing 18 in a position for the LED lamp 14 of the LED module 12 to emit light from the lamp fixture housing 18 through a housing opening 19 in a desired direction when a power supply module 20 (shown in FIG. 3) of the assembly 10 is receiving AC power from an AC electrical source 25 and is energizing the LED lamp 14.

As best shown in FIG. 3, the existing bayonet base lamp socket 16 that the LED module 12 may be configured to removably engage may include bayonet base lamp socket detents 22 configured to axially receive and then rotationally engage corresponding detents of a bayonet base lamp, e.g., a halogen lamp (not shown), which may be in the form of laterally-extending posts. The lamp socket detents 22 may include longitudinal slot portions configured to axially receive the bayonet base lamp detent posts and transverse slots portions configured to allow the bayonet base lamp detent posts to then be rotated into respective positions where the bayonet base lamp detent posts will axially engage the lamp detent transverse slot portions, precluding axial separation of the bayonet base lamp from the lamp socket 16 and housing 18. As is best shown in FIGS. 1 and 2, the existing lamp fixture housing 18 into which the LED module 12 may be configured to be received, may be carried by an elevator ceiling panel 23 within an elevator passenger compartment.

The LED module 12 may include two LED module detents that may be in the form of posts 24 laterally extending from a base or stem 27 of the LED module 12 and configured and positioned to allow the LED module stem 27 to be received axially into the bayonet base lamp socket 16 and then rotated such that the LED module detents 24 engage the transverse slot portions of the bayonet base lamp socket detents 22 so as to resist axial separation of LED module 12 from the lamp housing 18 as shown in FIG. 2. The LED module stem 27 may comprise an annular LED module heat sink fin. In other embodiments, the LED module detents 24 may extend from any LED module surface that will allow the LED module detents 24 to be configured and positioned to engage the lamp socket detents 22.

As shown in FIG. 3, the power supply module 20 may be coupled to the LED lamp 14, and may be configured to condition power received from an external electric power source 25 to power the LED lamp 14. The power supply module 20 may be further configured to be mounted remotely from the LED module 12. The external electrical source 25 may be AC building power supplied to an elevator carrying the bayonet base lamp fixture housing 18 and socket 16.

As best shown in FIGS. 2 and 3 the LED module 12 may also include a reflector 26 shaped in such a way, and a lens 28 fabricated in such a way, as to cause light from at least one LED lamp 14 supported within the LED module 12 to appear evenly distributed across the lens 28. As is also best shown in FIGS. 2 and 3, the LED module 12 may additionally include detents or tang receptacles 30 configured to be engaged by and to receive tangs 31 of a spanner-type installation and removal tool 33 so that the tool can be used to apply torque to the LED module 12 during installation and removal.

An LED retrofit assembly 10 configured as described above may be installed in a lamp socket 16 and received in a lamp housing 18 of an existing bayonet base lamp fixture via a method including the following steps:

The power supply module 20 of the LED retrofit assembly 10 may be disposed in a location remote from an existing bayonet base lamp socket 16 and housing 18 in which the LED module 12 of the assembly 10 is to be supported. For example, the power supply module 20 may be mounted above an elevator passenger compartment ceiling panel 23 through which a lamp supported by the lamp socket 16 would be positioned to shine. To free the existing bayonet base lamp socket 16 to receive the stem 27 of the LED module 12, any bayonet base lamp being carried by the socket 16 is first be removed from the socket 16. In addition, any existing lamp fixture power supply may be disconnected from its source 25 of electricity and may be removed. The LED retrofit assembly power supply module 20 is connected to the one or more LED lamps 14 of the LED module 12. The stem portion 27 of the LED module 12 is axially inserted into the empty bayonet base lamp socket 16 by passing the module 12 upward through a ceiling panel hole 32 and a lower housing opening 19 of the existing bayonet base lamp fixture housing 18. The LED module 12 is engaged in the bayonet base lamp socket 16 by inserting the stem portion 27 of the LED module axially into the socket 16 and then rotating the LED module 12 relative to the bayonet base lamp socket 16 to engage the LED module detent posts 24 with corresponding transverse slot portions of the bayonet base lamp socket detent slots 22 in such a way as to resist axial separation of the LED module 12 from the bayonet base lamp socket 16.

An LED retrofit assembly installed as described above allows a bayonet base lamp fixture to be efficiently converted to support an LED module. This description, rather than describing limitations of an invention, only illustrates an embodiment of the invention recited in the claims. The language of this description is therefore exclusively descriptive and is non-limiting. Obviously, it's possible to modify this invention from what the description teaches. Within the scope of the claims, one may practice the invention other than as described above.

1. An LED retrofit assembly for a bayonet base lamp socket, the assembly comprising:
an LED module comprising an LED lamp; and
a power supply module coupled to the LED lamp, configured to condition power received from an external power source to power the LED lamp, and further configured to be mounted remotely from the LED module, the LED module being configured to be removably supported by a bayonet base lamp socket in a position to emit light in a desired direction when the power supply is energizing the LED module.

2. An LED retrofit assembly as defined in claim 1 in which the LED module is configured to be removably supported by a bayonet base lamp socket including a first bayonet base lamp socket detent configured to axially receive a bayonet base lamp, and then allow the lamp to be rotated into engagement with the bayonet base lamp socket detent so as to resist axial separation of the bayonet base lamp from the lamp housing.

3. An LED retrofit assembly as defined in claim 2 in which the LED module includes a first LED module detent configured and positioned to allow a portion of the LED module to be received into the bayonet base lamp socket and then rotated to engage the first LED module detent with the bayonet base lamp socket detent so as to resist axial separation of LED module from the lamp housing.

4. An LED retrofit assembly as defined in claim 3 in which the LED module includes a second LED module detent configured and positioned to allow a portion of the LED module to be received into the bayonet base lamp socket and then rotated to engage a second LED module detent with the bayonet base lamp socket detent so as to cooperate with the first LED module detent and first bayonet base lamp socket detent in resisting axial separation of LED module from the lamp housing.

5. An LED retrofit assembly as defined in claim 1 in which the LED module includes a reflector shaped in such a way, and a lens fabricated in such a way, as to cause light from at least one LED supported within the LED module to appear evenly distributed across the lens.

6. An LED retrofit assembly as defined in claim 1 in which the LED module includes detents configured to be engaged by and to receive torque application from an installation and removal tool.

7. A method for installing an LED retrofit assembly, the method including the steps of
disposing a power supply of an LED retrofit assembly in a location remote from a bayonet base lamp socket in which an LED module of the assembly is to be supported;
connecting the power supply to an LED lamp of the LED module;
axially inserting a portion of the LED module axially into the bayonet base lamp socket; and
engaging the LED module in the bayonet base lamp socket against axial separation by rotating the LED module relative to the bayonet base lamp socket.

8. The method of claim 7 including the additional step of removing a bayonet base lamp from the bayonet base lamp socket before the step of inserting a portion of the LED module.

9. The method of claim 7 including the additional step of disconnecting a bayonet base lamp power supply from an electrical source.

10. The method of claim 7 in which the step of disposing a power supply of an LED retrofit assembly in a location remote from a bayonet base lamp socket includes disposing the power supply above a ceiling panel through which a lamp supported by the lamp socket would be positioned to shine.

11. The method of claim 7 in which:
the step of axially inserting a portion of the LED module axially into the bayonet base lamp socket includes passing the LED module upward through a ceiling panel hole through which a lamp carried by the bayonet base lamp socket would be positioned to shine; and
the step of rotating the LED module relative to the bayonet base lamp socket includes the step of engaging an LED module detent with a corresponding bayonet base lamp socket detent in such a way as to resist axial separation of the LED module from the bayonet base lamp socket.
